(19) United States
(12) Patent Application Publication
(10) Pub. No.: US 2010/0167586 A1
(43) Pub. Date: Jul. 1, 2010

(54) TELECOMMUNICATIONS CABLE CONNECTOR

(76) Inventor: Jukka Väyrynen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/593,453

(22) PCT Filed: Mar. 28, 2008
(86) PCT No.: PCT/FI08/50148

§ 371 Date: Feb. 24, 2010

(30) Foreign Application Priority Data
Mar. 29, 2007 (FI) 20075204

(51) Int. Cl. H01R 13/648; H01R 13/02; H01R 43/00

(52) U.S. Cl. 439/607.34; 439/884; 29/825

(57) ABSTRACT

A telecommunications connector is provided for establishing a connection between a telecommunications device. The telecommunications cable connector comprises at least one male connector having at least one conductor wrapped in a helical fashion along the entire length of the contact portion of the male connector, at least one female connector having an intermating contact surface compatible with said at least one helically wrapped conductor of the male connector, and at least one shield element for shielding the contact established between said at least one helically wrapped conductor of the male connector and the intermating contact surface of the female connector.

### BACKGROUND

Connections between different of telecommunications equipment and a telecommunications network are established by means of a connection cable attached to a telecommunications device at its one end and further to the telecommunications network with the help of a connector.

### STATE OF THE ART

Conventionally, a telecommunications cable comprises at least one pair of conductors that in the cable structure may run adjacently parallel to each other or in a intertwined fashion, the latter being called a twisted-wire cable. In its entirety, a telecommunications cable may comprise more than one pair of conductors with adjacently parallel conductors or more than one twisted pair of conductors. Additionally, also the twisted-wire conductor pairs may be twisted with each other, either along the entire length of the telecommunications cable or only along a shorter section of the cable.

The internet and a computer hooked to a wired telecommunications network communicate with each other over an interface device and telecommunications cables. The telecommunications cable leaving the interface device is called a connection cable. The other end of the connection cable is typically hooked to a telecommunications cable known as a riser cable routed along the constructions of a building. The riser cable is connected at a termination box mounted on an interior wall of the building to a device connection cable whose other end is hooked to terminal device such as a computer.

Different kinds of telecommunications cables are joined with each other or various devices by connector means. A telecommunications cable connector system typically comprises a male connector and a female connector. The male connectors are generally mounted at the cable ends, while the female connectors are permanently mounted on the equipment or the building wall structures. The connector means of a telecommunications cable is connected by inserting the male connector into the female connector so that, e.g., a male connector mounted at one end of a device connection cable is inserted into a female connector of a termination box mounted on the interior wall of a room, whereby the computer can establish a connection with a telecommunications network for receiving/transmitting data.

A prior-art telecommunications cable connector system depicted in FIGS. 1A-1B is principally characterized in that the contact surfaces 1 mating the male connector with the female connector are substantially planar.

Prior-art connector systems have been hampered by such problems as crosstalk, reflections and electromagnetic interference due to defective contact over the male/female contact surfaces and/or insufficient shielding, whereby external disturbance sources can interfere with the telecommunications connection. As a result, the quality of service over the telecommunications connection is deteriorated causing an increased error rate in the data transfer and also preventing the use of higher data rates.

### BRIEF DESCRIPTION OF THE INVENTION

It is an object of the present invention to provide a connector system for hooking a telecommunications connection in which system the connector construction secures an error-free telecommunications connection thus also facilitating the use of higher data rates. This goal is achieved by means of a telecommunications connector construction according to the invention suited for establishing a connection between a telecommunications device and a telecommunications network. A telecommunications cable connector pair comprises at least one male connector in which at least one conductor is helically wrapped about the entire length of the male connector contact surface portion and at least one female connector comprising at least one contact surface intermatingly compatible with said at least one helically wrapped conductor of the male connector.

The invention also relates to a method of establishing a connection between a telecommunications device and a telecommunications network. The method comprises a step of intermating at least one conductor that is helically wrapped about the contact surface portion of the male connector with at least one compatible contact surface of the female connector.

One of the requirements for a functional telecommunications connection is that the connector establishes a good contact between the female connector and the male connector.

The goal of the invention is achieved by adapting at least one conductor of the telecommunications cable in a helically wrapped fashion about the male connector substantially along the entire length of the contact portion of the male connector and by providing the female connector with an intermating contact surface compatible with said at least one helically wrapped conductor of the male connector, whereby the single/dual/multiple-wire helical wrapping of the conductor extends substantially along the entire length of the connector pair. This arrangement allows the potentially available contact surface area of one or more conductors intermating with the contact surface of the female connector to be increased even by a manyfold amount in regard with a prior-art embodiment in which the conductors are aligned in a linear fashion in the contact portion of the male connector.

The main benefit of the invention is that it allows a sufficiently large contact area to be established between the male connector and the female connector thus reducing the interface impedance of the contact. The contact area is also shielded substantially over the entire length of the connector pair, which is a significant advantage in regard with such factors as reflections, crosstalk and electromagnetic interference hampering telecommunications lines.

### BRIEF DESCRIPTION OF DRAWINGS

FIGS. 1 A-B depicts a conventional telecommunications cable connector;

FIG. 2 depicts a telecommunications cable connector according to the invention;

FIGS. 3 A-C depicts a telecommunications cable connector according to the invention;

FIG. 4 depicts a telecommunications cable connector according to the invention;

FIGS. 5A-5D depicts an embodiment of the telecommunications cable connector according to the invention for a twisted four-pair cable.

### DETAILED DESCRIPTION OF THE INVENTION

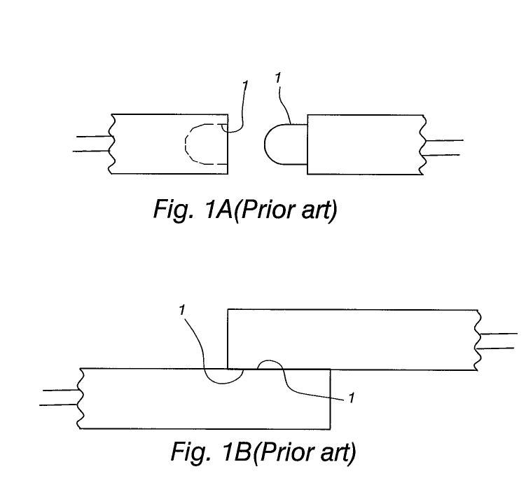

Referring to FIGS. 1A and 1B, the main elements of a telecommunications connector system are a male connector at the end of a telecommunications device connection cable and a female connector mounted, e.g., on the interior wall of a building. The male connector must be insertable in the female connector so that a contact with a sufficiently large area is formed from the conductors of the male connector to the contact surface of the female connector. Additionally, the male connector must mate with the female connector so securely that the contact pair cannot be separated due to, e.g., movements of the telecommunications cable.

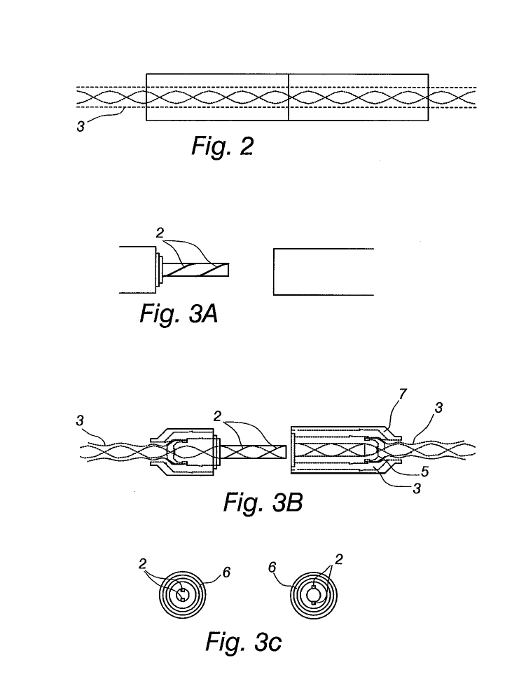

In a preferred embodiment of the invention shown in FIG. 2 and FIGS. 3A-3C, the telecommunications cable connector comprises at least one male connector portion wherein two conductors 2, for instance, are helically wrapped substantially symmetrically with regard to each other along the entire length of the contact surface area of the male connector. Assuming that the conductors 2 operate at potentials of equal magnitude but opposite polarities as is the case in symmetric data communications cables, the electric fields created by the opposite-polarity voltages cancel each other if the conductors 2 are arranged to be helically twisted about the male connector contact portion substantially symmetrically. Also the currents in conductors 2 have equal magnitudes but opposite directions, whereby also the magnetic fields induced by the currents cancel each other under the above-mentioned conditions of symmetry. The conductor symmetry maintains the common-mode voltage between the conductors unchanged under the influence of an interfering disturbance voltage thus preventing any interference by a disturbing electric field from downgrading the quality of service on a telecommunications line. Owing to the helically twist and symmetry of the conductor pair, when the flow of a magnetic flux through any open loop formed between the twists of the conductors induces disturbance currents, these current components cancel each other at each successive helical twist of the conductor pair. The greatest advantages of conductor symmetry are realized by having the conductors helically twisted along the entire length of the telecommunications cable and arranging the configuration of the conductors to continue in a symmetrical fashion also substantially along the entire length of the connector.

The female connector depicted in FIG. 3B comprises a contact surface that is compatible with the conductor geometry of the male connector. The mating contact area between the male connector conductors 2 and the contact surface of the female connector can be increased by increasing the twisting pitch of conductors 2 about the male connector center core. The conductor tails intended to face the female connector contact surface are peeled thus lacking an insulation such as a polymer material insulation. The conically tapering shape of the male connector center core further secures that the male connector with the helically twisted conductors on its center core can be firmly mated with the compatibly tapered bore of the female connector, against the contact surface thereof. The mated connectors are secured by a locking means, such as clips, adapted to function between the female connector and the male connector.

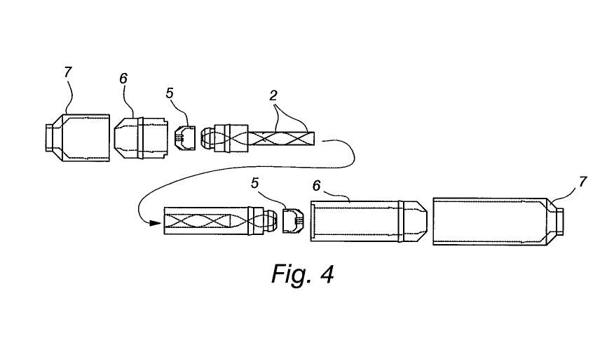

This intermating contact must also be sufficiently shielded to prevent external disturbance sources from interfering excessively with the telecommunications connection. One of the qualities of the preferred embodiment of present invention is characterized in that the contact formed between said at least one conductor of the male connector and the compatibly intermating contact surface of the female connector is shielded substantially over the entire length of the connector pair. Thus the telecommunications cable connector may comprise a shield element 6, 7 (FIGS. 3B-3C and 4) for shielding the contact between the male connector conductors and the female connector contact surface. Under a protective sleeve 7, the shield element comprises, e.g., a tubular metallic shield member 6 having a conical or cylindrical shape. The connector embodiment according to the invention may further comprise a spacer ferrule 5 that is insertable into the interior space of the connector body and serves as a support whereto the shield member 6 is attached. Since the shield member 6 provides a static shield along the entire length of the connector pair, external disturbance sources are prevented from acting as error factors in the quality of service of the telecommunications connection. The most effective shielding effect is attained when the shield member complements the contiguous shield 3 of the entire length of the telecommunications cable thus extending the shield also about the connector pair. This arrangement prevents, e.g., the origination of crosstalk or reflections thereby securing a continually error-free telecommunications connection.

Unlike depicted in FIGS. 3B-3C and 4, the shield member 6 and/or the protective sleeve 7 can comprise one or more parts; for example a two-parted structure can be good when an object is to reach fast assembling times.

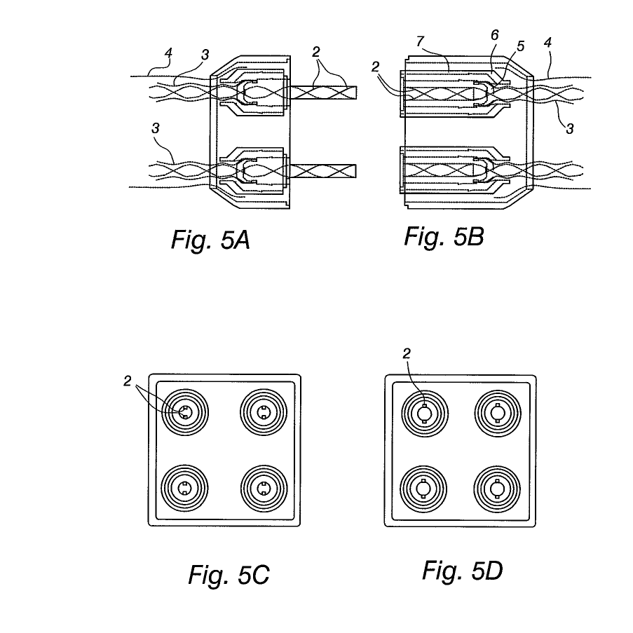

In twisted four-pair twisted-(conductor)pair cables the conductors comprise four mutually intertwined twisted pairs of conductors, whereby also the twisted pairs are also twisted with each other. An embodiment of the telecommunications cable connector (FIGS. 5A-5D) for a four-pair twisted-pair cable is implemented as connector system comprising four female connectors adapted adjacent to each other into a square formation and, respectively, four male connectors assembled so as to mate with the female connectors.

It is obvious that the invention is not limited by the exemplary embodiments elucidated above in the description part of the present application by virtue of making reference to the drawings therewith, but rather may be varied within the inventive spirit and scope of the appended claims.

1. A telecommunications cable connector for establishing a connection between a telecommunications device and a telecommunications network, said telecommunications cable connector comprising: at least one male connector having at least one conductor helically wrapped along substantially an entire length of a contact surface of the at least one male connector, and at least one female connector having an intermating contact surface compatible with said at least one helically wrapped conductor of the male connector.

2. The telecommunications cable connector of claim 1, wherein the connector comprises at least one shield element for shielding the contact established between said at least one helically wrapped conductor of the male connector and the intermating contact surface of the female connector.

3. The telecommunications cable connector of claim 1, wherein at least two conductors are helically wrapped substantially symmetrically with regard to each other along the length of the contact surface of the male connector.

4. The telecommunications cable connector of claim 1, wherein the contact surface of said male connector is conically tapering and the contact surface of said female connector comprises a conically tapered bore substantially compatible with the contact surface of the male connector.

5. The telecommunications cable connector of claim 1, wherein the contact surface of said male connector is cylindrical and the contact surface of said female connector comprises a cylindrical bore substantially compatible with the contact surface of the male connector.

6. The telecommunications cable connector of claim 1, wherein the telecommunications cable connector further comprises a spacer element having a shield element attached thereto.

7. A method for establishing a connection between a telecommunications device and a telecommunications network, the method comprising: mating a male connector having at least one conductor helically wrapped substantially along a length of a contact surface of the male connector with at least one intermating contact surface of a female connector.

8. The method of claim 7, wherein mating the male connector with the female connector further comprises mating the male connector with the female connector such that the connection between said male connector and said female connector is shielded.

9. The method of claim 7, wherein mating the male connector with the female connector further comprises mating a male connector having at least two conductors helically wrapped substantially symmetrically with regard to each other along the length of the contact surface of the male connector with the at least one intermating contact surface of the female connector.

10. The method of claim 7, wherein mating the male connector with the female connector further comprises mating the male connector with the female connector by inserting a conically tapering contact surface of the male connector into a conically tapered bore of the female connector, the conically tapered bore being substantially compatible with the male connector contact surface, so as to form the connection.

11. The method of claim 7, wherein mating the male connector with the female connector further comprises mating the male connector with the female connector by inserting a cylindrical contact surface of the male connector into a cylindrical bore of the female connector, the cylindrical bore being substantially compatible with the male connector contact surface, so as to form the connection.

12. The method of claim 7, wherein mating the male connector with the female connector further comprises mating the male connector with the female connector such that the connection between said male connector and said female connector is shielded by a spacer element having a shield element attached thereto.
